(19) United States
(12) Patent Application Publication
(10) Pub. No.: US 2004/0138984 A1
(43) Pub. Date: Jul. 15, 2004

(54) Notes payable management system and method

(76) Inventor: Juei-Mei Wang, Santa Clara, CA (US)

Correspondence Address: WEI TE CHUNG, FOXCONN INTERNATIONAL, INC., 1650 MEMOREX DRIVE, SANTA CLARA, CA, 95050, US

(21) Appl. No.: 10/744,201

(22) Filed: Dec. 22, 2003

(30) Foreign Application Priority Data
Dec. 20, 2002 (TW) 91136952

(51) Int. Cl. G06F 17/60

(52) U.S. Cl. 705/36

(57) ABSTRACT

A system for notes payable management includes client computers (10), an application server (12), and a database (14). The application server includes a basic information maintaining module (21), a notes payable opening module (22), a notes payable printing module (23), an auditing module (24), an amending module (25), a transferring module (26), a cashing module (27), and a statement generating module (28). The notes payable opening module is for opening new notes payable. The notes payable printing module is for printing notes payable. The auditing module is for determining whether the printed notes payable can be approved for issue. The amending module is for determining whether the approved notes payable need to be amended and amends such notes payable. The transferring module is for transferring notes payable. And the cashing module is for cashing notes payable. The client computers are connected to the application server through an electronic network (11).

### BACKGROUND OF THE INVENTION

1. Field of the Invention

The present invention relates to a computer-enabled notes payable management system and method, and particularly to a notes payable management system and method that can manage all operations involved in handling notes payable.

2. Background of the invention

Efficient management of notes payable is vital for large-scale businesses such as multinational manufacturing corporations. When a note payable should be opened and what classification it should have are important because these factors are related to the flow of finances and credit standing of a corporation. Operations involved in handling notes payable typically include opening, issuing, auditing, amending, voiding, and cashing. There is a vast range of notes payable management software available in the marketplace. However, most of these programs are basically directed to speeding up the operations of notes payable, and lack adequate functions for managing operations of notes payable.

Computer-aided notes payable management systems are disclosed in a number of patents. U.S. Pat. No. 5,121,945 issued on Jun. 16, 1992 and entitled “Financial Data Processing System” discloses methods and systems for effecting the accounting functions of debiting and crediting a bank's accounting records, a payer's bank account records and a corporation's accounts receivable records with the bank's customer's payments. The methods and systems are based upon the combination of data from two or more sources to prepare an integrated document. The methods and systems concentrate on dealing with the bank's accounting records. However, the methods and systems do not provide for management of notes payable.

### SUMMARY OF THE INVENTION

Accordingly, a main objective of the present invention is to provide a notes payable management system and method, whereby users can control all operations involved in handling notes payable, so that notes payable can be readily traced wherever they may be in the handling process.

To accomplish the above objective, a notes payable management system in accordance with a preferred embodiment of the present invention includes a plurality of client computers, an application server and a database. Each client computer provides a user interface for inputting and displaying basic information. The application server includes: a basic information maintaining module for maintaining basic information; a notes payable opening module for opening new notes payable; a notes payable printing module for assigning a dedicated note number to each processed note payable and printing the note payable; an auditing module for auditing the printed notes payable in order to determine whether the printed notes payable can be approved for issue; an amending module for determining whether the approved notes payable need to be amended and amending such notes payable; a transferring module for transferring notes payable; a cashing module for cashing notes payable; and a statement generating module for generating statements. The database stores all kinds of data used and generated during the above-described processes. The client computers are connected to the application server through an electronic network. The application server is connected to the database through a connection.

Further, the present invention provides a notes payable management method comprising the steps of: (a) setting basic information; (b) opening notes payable; (c) assigning a dedicated number to each note payable and printing the note payable; (d) determining whether the printed notes payable can be approved for issue; (e) reopening new notes payable if the printed notes payable cannot be approved for issue; (f) determining whether the approved notes payable need to be amended if the printed notes payable can be approved for issue; (g) determining whether the notes payable should be voided if the approved notes payable need to be amended; (h) amending such notes payable if the notes payable should not be voided; (i) carrying forward balances of such notes payable to accounts payable and reopening new notes payable if the notes payable should be voided; (j) transferring notes payable; (k) cashing notes payable; and (l) generating corresponding statements.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a notes payable management system in accordance with the preferred embodiment of the present invention;

FIG. 2 is a schematic diagram of main function units of an application server of the notes payable management system of FIG. 1; and

FIG. 3 is a flowchart of a preferred method for implementing the notes payable management system of the present invention.

### DETAILED DESCRIPTION OF THE INVENTION

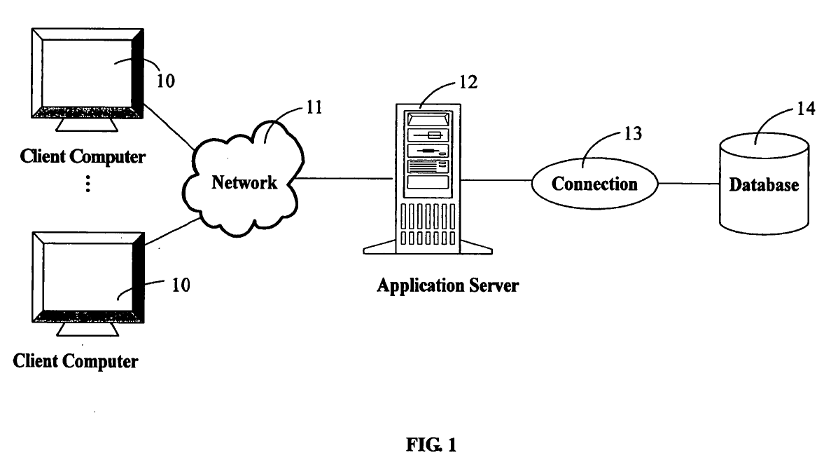

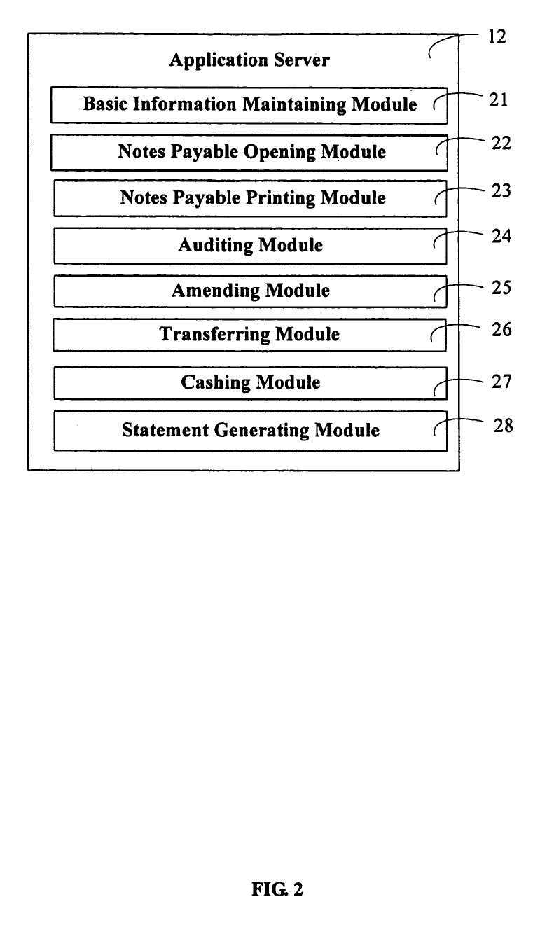

FIG. 1 is a schematic diagram of hardware infrastructure of a notes payable management system in accordance with the preferred embodiment of the present invention. The notes payable management system comprises a plurality of client computers 10, an application server 12, and a database 14. The client computers 10 are connected to the application server 12 through an electronic communications network 11. The network 11 may be any suitable communication architecture required by the notes payable management system, such as a local area network or a wide area network. The application server 12 is connected to the database 14 through a connection 13. The connection 13 is a database connectivity such as an Open Database Connectivity (ODBC) or a Java Database Connectivity (JDBC). Each client computer 10 provides an interactive user interface for users to maintain basic information and view statements. The application server 12 comprises a plurality of function units (described in detail below in relation to FIG. 2). The application server 12 can retrieve data through the client computers 10, process the data, and display processing results through the client computers 10. The database 14 stores all kinds of data used and generated in the above-described processes.

FIG. 2 is a schematic diagram of main function units of the application server 12. The application server 12 comprises a basic information maintaining module 21, a notes payable opening module 22, a notes payable printing module 23, an auditing module 24, an amending module 25, a transferring module 26, a cashing module 27, and a statement generating module 28.

The basic information maintaining module 21 maintains basic information, including by way of adding, modifying, searching and deleting basic information. The basic information may include accounts, journal entries, accounts payable, and statement templates. Journal entries are records of business activities made according to one or more accounting methods.

The notes payable opening module 22 is used for opening new notes payable. Notes payable typically include checks, promissory notes and bills of exchange. Each of these kinds of notes payable has at least one drawer bank. The notes payable opening module 22 opens notes payable based on accounts payable, the accounts payable being provided by the basic information maintaining module 21. The notes payable opening module 22 selects an account payable, a drawer bank and a kind of note payable, and opens a note payable accordingly. The notes payable opening module 22 can open more than one note payable at the same time, in the case where all the drawers of notes payable are a same bank. Once the notes payable are opened, a dedicated business number and corresponding journal entries for each note payable are generated. The dedicated business number represents a related business activity. When a note payable is opened, the note payable is marked “processed.” The processed notes payable, the dedicated business numbers, and the corresponding journal entries are all stored in the database 14.

The notes payable printing module 23 assigns a dedicated note number to each processed note payable. The dedicated note number is each note payable's ID, and is stored in the database 14. The notes payable printing module 23 also prints the notes payable that have had dedicated note numbers assigned to them. Users can select the dedicated note numbers in order to print the notes payable, whereupon the notes payable are respectively marked “printed.” The printed notes payable are stored in the database 14.

The auditing module 24 is used for auditing the printed notes payable, in order to determine whether the printed notes payable can be approved for issue. The criteria used in auditing typically include: whether the business activities corresponding to the notes payable are normal; and whether contents of the notes payable are all correct. If a note payable satisfies the criteria, the note payable is marked “approved,” and the approved note payable is stored in the database 14.

The amending module 25 determines whether the approved notes payable need to be amended, and amends any such notes payable accordingly. That is, before a note payable is to be approved for issue, a contingency may have arisen such that the note payable needs to be amended. For example: erroneous data on a note payable may result in it being voided and in the need to reopen a new note payable; unforeseen circumstances or negotiation between a drawer and a drawee may result in amendment of a date or of other terms; or the provision of unsatisfactory products or services may temporarily suspend eligibility for the note payable. Amendments typically include voiding a note payable, reopening a new note payable, and amending data on a note payable. All amended notes payable are stored in the database 14.

The transferring module 26 provides at least two types of methods of transferring, namely transferring by mail (i.e. by postal service) and personal collection by drawees. The transferring module 26 respectively displays the notes payable sent by mail and personally collected by drawees. When a note payable is transfered by mail, the fee for mailing is calculated and displayed in a separate column.

The cashing module 27 is for cashing notes payable. That is, when a note payable becomes due and is required to be cashed, the cashing module 27 generates corresponding journal entries automatically, and a user then notifies the drawer bank to cash the note payable. Notes payable that have been cashed are respectively marked “cashed,” and are stored in the database 14.

The statement generating module 28 generates statements according to predefined statement templates and particular terms set by respective users. The statement templates may include notes payable detailed statements by drawer banks, notes payable detailed statements by drawees, notes payable detailed statements by statuses, and so on. The terms set by a user typically include drawer banks, drawees, statuses of notes payable, and so on. The statuses of notes payable include processed, printed, approved, and cashed.

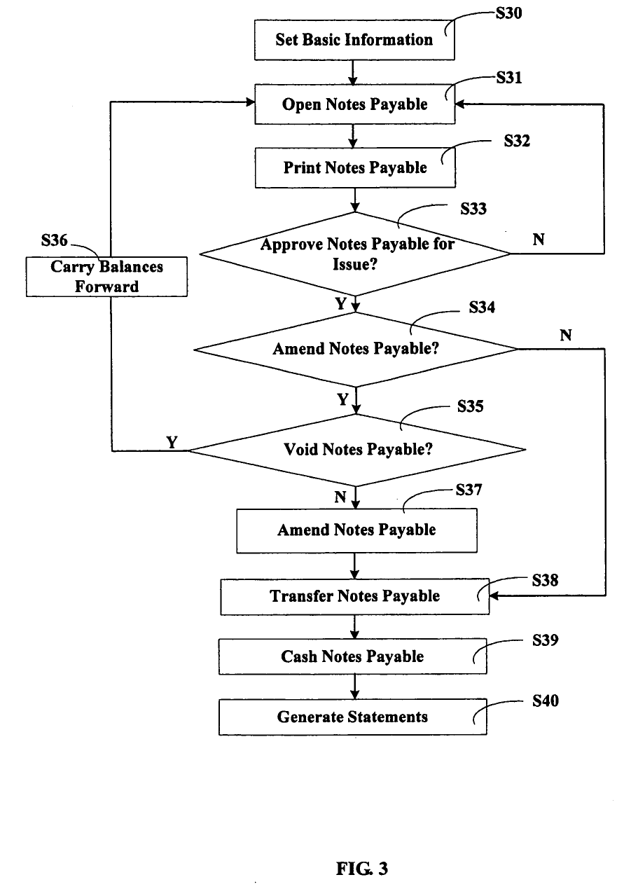

FIG. 3 is a flowchart of a preferred method for implementing the notes payable management system of the present invention. In step S30, the basic information maintaining module 21 sets basic information such as accounts, journal entries, accounts payable and statement templates. The basic information as set is stored in the database 14, and can be searched by any user through any client computer 10. In step S31, the notes payable opening module 22 selects an account payable, a drawer bank and a kind of note payable, and opens one or more notes payable accordingly. When the notes payable are opened, they are respectively marked “processed.” In step S32, the notes payable printing module 23 assigns a dedicated note number to each processed note payable. Users can select the dedicated note numbers to print the notes payable, whereupon the notes payable are marked “printed.” In step S33, the auditing module 24 determines whether the printed notes payable can be approved for issue. If any printed notes payable can be approved for issue, the procedure goes to step S34 described below in relation to such notes payable. If any printed notes payable cannot be approved for issue, the status of such notes payable is changed from “printed” to “processed,” and the procedure returns to step S31 described above in relation to such notes payable. In step S34, the amending module 25 determines whether any of the approved notes payable need to be amended. If any approved notes payable do not need to be amended, the procedure goes directly to step S38 described below in relation to such notes payable. If any approved notes payable need to be amended, in step S35, the amending module 25 determines whether such notes payable should be voided. If any notes payable should be voided, in step S36, balances of such notes payable are carried forward to corresponding accounts payable, whereupon the procedure returns to step S31 described above in relation to such notes payable. If any notes payable should not be voided, in step S37, the amending module 25 amends such notes payable, whereupon the procedure goes to step S38 in relation to such notes payable. In step S38, the transferring module 26 controls transferring of the notes payable to drawees by mail and/or by personal collection by drawees. In step S39, the cashing module 27 cashes due notes payable. That is, when a note payable becomes due and is required to be cashed, the cashing module 27 generates corresponding journal entries automatically, and then a user notifies the drawer bank to cash the note payable. Notes payable that have been cashed are marked “cashed.” Finally, in step S40, the statement generating module 28 generates corresponding statements. The statements can be displayed to a user through the interface of the relevant client computer 10, stored in the database 14, and printed.

Although the present invention has been specifically described on the basis of a preferred embodiment and a preferred method, the invention is not to be construed as being limited thereto. Various changes and modifications may be made to the embodiment and method without departing from the scope and spirit of the invention.

What is claimed is:

1. A notes payable management system for managing operations of notes payable, comprising:
a plurality of client computers, each of the client computers providing a user interface for inputting and displaying data;
a database for storing information; and
an application server comprising:
a notes payable opening module for opening new notes payable;
a notes payable printing module for assigning a dedicated note number to each processed note payable and printing the note payable;
an auditing module for auditing the printed notes payable to determine whether the printed notes payable can be approved for issue;
an amending module for determining whether approved notes payable need to be amended and amending such notes payable as needed;
a transferring module for transferring notes payable; and
a cashing module for cashing notes payable.

2. The notes payable management system according to claim 1, further comprises a basic information maintaining module for adding, modifying, searching and deleting basic information.

3. The notes payable management system according to claim 1, further comprising a statement generating module for generating statements according to predefined statement templates and particular terms set by respective users.

4. The notes payable management system according to claim 1, wherein terms set by respective users include drawer banks, drawees, statuses of notes payable, the statuses of notes payable comprising processed, printed, approved, and cashed.

5. A computer-enabled notes payable management method, comprising the steps of:
opening notes payable;
assigning a dedicated number to each note payable and printing the note payable;
determining whether the printed notes payable can be approved for issue;
determining whether approved notes payable need to be amended in respect of printed notes payable that can be approved for issue;
determining whether approved notes payable should be voided in respect of approved notes payable that need to be amended;
amending approved notes payable in respect of approved notes payable that should not be voided;
transferring unamended and amended notes payable; and
cashing transferred notes payable.

6. The method according to claim 5, further comprising the step of setting basic information through a user interface.

7. The method according to claim 5, further comprising the step of generating corresponding statements.

8. The method according to claim 5, further comprising the step of reopening new notes payable in respect of printed notes payable that cannot be approved for issue.

9. The method according to claim 5, further comprising the step of carrying forward balances of approved notes payable to accounts payable and reopening new notes payable in respect of approved notes payable that should be voided.
